(19) United States
(12) Patent Application Publication
(10) Pub. No.: US 2026/0042061 A1
(43) Pub. Date: Feb. 12, 2026

(54) CATALYST BODY AND EXHAUST GAS AFTERTREATMENT SYSTEM

(71) Applicant: CUMMINS INC., Columbus, IN (US)

(72) Inventors: Ashok Kumar, Columbus, IN (US); Krishna Kamasamudram, Columbus, IN (US); Arvind Suresh, Columbus, IN (US)

(73) Assignee: CUMMINS INC., Columbus, IN (US)

(21) Appl. No.: 19/101,782

(22) PCT Filed: Aug. 15, 2023
(86) PCT No.: PCT/US2023/030200

§ 371 Date: Feb. 6, 2025

Related U.S. Application Data
(60) Provisional application No. 63/398,321, filed on Aug. 16, 2022.

(51) Int. Cl. B01D 53/94; B01J 23/42; B01J 23/44; B01J 23/46; B01J 35/70

(52) U.S. Cl. CPC B01D 53/9418; B01D 53/944; B01J 23/42; B01J 23/44; B01J 23/464; B01J 35/733; B01D 2255/9032; B01D 2255/915

(57) ABSTRACT

A catalyst body for an exhaust gas aftertreatment system includes a first portion having a selective catalytic reduction S(SCR) catalyst member that receives exhaust gas. The SCR catalyst member includes a first end and a second end opposite the first end. The exhaust gas is configured to flow through the SCR catalyst member in a direction from the first end to the second end. The catalyst body further includes a second portion having an oxidation catalyst member. The oxidation catalyst member includes a coating thereon at a location proximate the second end of the SCR catalyst member. The oxidation catalyst member is fluidly coupled to the SCR catalyst member and receives the exhaust gas from the SCR catalyst member via the second end of the SCR catalyst member.

### CROSS-REFERENCE TO RELATED APPLICATION

This application claims the benefit of and priority to U.S. Provisional Patent Application No. 63/398,321, filed Aug. 16, 2022, which is incorporated herein by reference in its entirety.

### TECHNICAL FIELD

The present application relates generally to a catalyst body for an exhaust gas aftertreatment system of an internal combustion engine.

### BACKGROUND

Internal combustion engines (ICEs), such as hydrogen (H₂) ICEs and diesel ICEs, emit nitrogen oxide (NOₓ) compounds in exhaust gas. It may be desirable to reduce NOₓ emissions to comply with environmental regulations, for example. To reduce NOₓ emissions, a reductant may be dosed into the exhaust gas by a dosing system and within an aftertreatment system. The reductant facilitates conversion of a portion of the exhaust gas into non-NOₓ emissions, such as nitrogen (N₂), carbon dioxide (CO₂), and water (H₂O), thereby reducing NOₓ emissions. H₂ may also be emitted in the exhaust gas, which may be regulated in the future by government entities.

### SUMMARY

In one embodiment, a catalyst body for an exhaust gas aftertreatment system includes a first portion having a selective catalytic reduction (SCR) catalyst member that receives exhaust gas. The SCR catalyst member includes a first end and a second end opposite the first end. The exhaust gas is configured to flow through the SCR catalyst member in a direction from the first end to the second end. The catalyst body further includes a second portion having an oxidation catalyst member. The oxidation catalyst member includes a coating thereon at a location proximate the second end of the SCR catalyst member. The oxidation catalyst member is fluidly coupled to the SCR catalyst member and receives the exhaust gas from the SCR catalyst member via the second end of the SCR catalyst member.

In another embodiment, an exhaust gas aftertreatment system includes a decomposition chamber that receives an exhaust gas from an engine and a treatment fluid from a dosing module. The exhaust gas aftertreatment system further includes a catalyst body disposed downstream of the decomposition chamber. The catalyst body includes a first portion including a selective catalytic reduction (SCR) catalyst member that receives the exhaust gas. The SCR catalyst member includes a first end and a second end opposite the first end. The exhaust gas flows through the SCR catalyst member in a direction from the first end to the second end. The catalyst body further includes a second portion including an oxidation catalyst member including a coating thereon at a location proximate the second end of the SCR catalyst member. The oxidation catalyst member is fluidly coupled to the SCR catalyst member and receives the exhaust gas from the SCR catalyst member via the second end of the SCR catalyst member.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block schematic diagram of an example exhaust gas aftertreatment system;

FIG. 2 is a block schematic diagram of an example catalyst body including a coating;

FIG. 3 is a block schematic diagram of another example catalyst body including the coating;

FIG. 4 is an example graph of a length of the coating versus a space velocity for the coating; and

FIG. 5 is an example graph of a H₂ conversion rate versus the space velocity for the coating.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and for decomposing constituents of exhaust gas in an exhaust gas aftertreatment system of an internal combustion engine (ICE). The various concepts introduced above and discussed in greater detail below may be implemented in any of a number of ways, as the described concepts are not limited to any particular manner of implementation. Examples of specific implementations and applications are provided primarily for illustrative purposes.

In a H₂ ICE, H₂ may burn (e.g., combust, etc.) in a lean environment (e.g., an air-to-fuel ratio larger than one) to generate mechanical or electrical energy. After air and H₂ mix and burn in a combustion chamber of the ICE, NOₓ and some amount (e.g., few hundred or few thousand ppms (parts per millions)) of H₂ may be present in exhaust gas, particularly at cold-start, idle, transient, or low temperature operation of the ICE. An exhaust gas aftertreatment system may be disposed downstream of the ICE to convert harmful NOₓ into benign N₂ in a decomposition chamber of the exhaust gas aftertreatment system. H₂, which is a fuel in this case, or ammonia (NH₃) may be used as a treatment fluid (e.g., reductant, etc.) for the NOₓ conversion. H₂ from the exhaust gas can achieve the NOₓ conversion, or optional H₂ stream flowing from a fuel source (e.g., H₂ source) into the exhaust gas may also be used achieve the NOₓ conversion. Despite H₂ being used as the reductant for the NOₓ conversion, there is a possibility of unburnt H₂ emissions in the exhaust gas escaping the exhaust gas aftertreatment system 100 into atmosphere. The catalyst body disclosed herein includes an oxidation catalyst member that oxidizes the H₂.

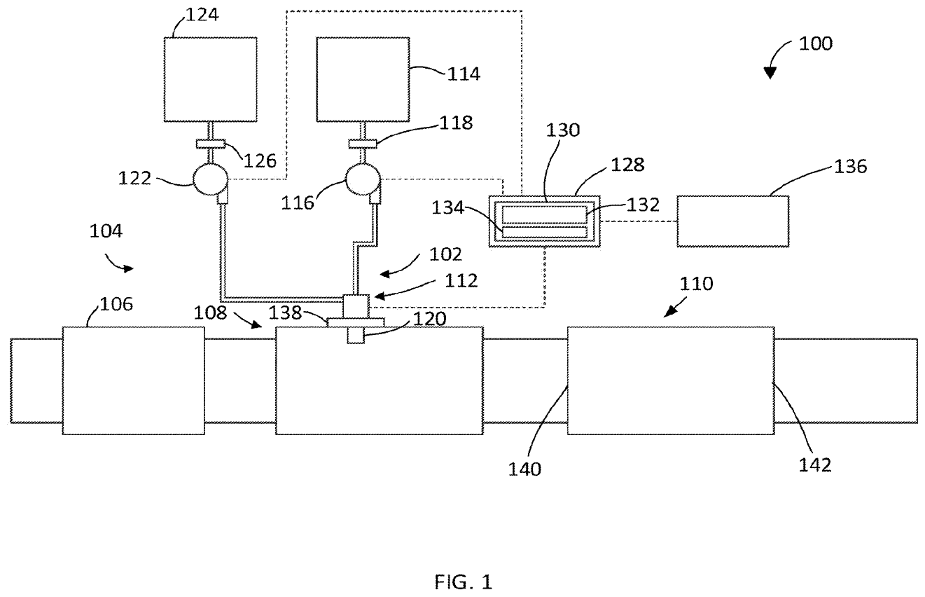

FIG. 1 depicts an exhaust gas aftertreatment system 100. The exhaust gas aftertreatment system 100 includes an exhaust gas conduit system 104 (e.g., pipe system, tube system, etc.) and a reductant delivery system 102 for the exhaust gas conduit system 104. The exhaust gas aftertreatment system 100 further includes a particulate filter 106 (e.g., a diesel particulate filter (DPF), etc.). The particulate filter 106 is configured to remove particulate matter (e.g., soot, urea, NH₃ based particulate matter, etc.) from exhaust gas flowing in the exhaust gas conduit system 104. The particulate filter 106 includes an inlet, where the exhaust gas is received, and an outlet, where the exhaust gas exits after having particulate matter substantially filtered from the exhaust gas and/or converting the particulate matter into carbon dioxide. In some implementations, the particulate filter 106 may be omitted.

The exhaust gas aftertreatment system 100 further includes a decomposition chamber 108 (e.g., decomposition reactor, reactor pipe, decomposition tube, reactor tube, etc.). The decomposition chamber 108 may be disposed downstream of the particulate filter 106. The decomposition chamber 108 is configured to convert a reductant into ammonia. The reductant may be, for example, urea, diesel exhaust fluid (DEF), Adblue®, a urea water solution (UWS), an aqueous urea solution (e.g., AUS32, etc.), and other similar fluids. The decomposition chamber 108 includes an inlet fluidly coupled to (e.g., fluidly configured to communicate with, etc.) the outlet of the particulate filter 106 and configured to receive the exhaust gas containing NOₓ emissions from the outlet of the particulate filter 106. The decomposition chamber 108 further includes an outlet configured to output the exhaust gas, NOₓ emissions, ammonia, and/or reductant.

The reductant delivery system 102 includes a dosing module 112 (e.g., doser, etc.) configured to dose the reductant into the decomposition chamber 108. The dosing module 112 is mounted to the decomposition chamber 108 such that the dosing module 112 may dose the reductant into the exhaust gas flowing in the exhaust gas conduit system 104. The dosing module 112 may include an insulator 138 interposed between a portion of the dosing module 112 and the portion of the decomposition chamber 108 on which the dosing module 112 is mounted.

The reductant delivery system 102 further includes a reductant source 114. The dosing module 112 may be fluidly coupled to the reductant source 114. The reductant source 114 may include multiple reductant sources 114. The reductant source 114 may be, for example, a diesel exhaust fluid tank containing Adblue®. The reductant delivery system 102 further includes a reductant pump 116 (e.g., supply unit, etc.) used to pressurize the reductant from the reductant source 114 for delivery to the dosing module 112. In some embodiments, the reductant pump 116 is pressure controlled (e.g., controlled to obtain a target pressure, etc.). The reductant pump 116 includes a reductant filter 118. The reductant filter 118 filters (e.g., strains, etc.) the reductant prior to the reductant being provided to internal components (e.g., pistons, vanes, etc.) of the reductant pump 116. For example, the reductant filter 118 may inhibit or prevent the transmission of solids (e.g., solidified reductant, contaminants, etc.) to the internal components of the reductant pump 116. In this way, the reductant filter 118 may facilitate (e.g., allow, permit, etc.) prolonged desirable operation of the reductant pump 116. In some embodiments, the reductant pump 116 is coupled to (e.g., attached to, fixed to, welded to, integrated with, etc.) a chassis of a vehicle associated with the exhaust gas aftertreatment system 100.

The dosing module 112 includes at least one injector 120. Each injector 120 is configured to dose the reductant into the exhaust gas (e.g., within the decomposition chamber 108, etc.). In some embodiments, the reductant delivery system 102 further includes an air source 124 (e.g., air intake, etc.). The air source 124 may include multiple air sources 124. The reductant delivery system 102 further includes an air pump 122 (e.g., supply unit, etc.) used to pressurize the air from the air source 124 for delivery to the dosing module 112. The air pump 122 may be pressure controlled. The air pump 122 includes an air filter 126. The air pump 122 is configured to draw air from the air source 124 through the air filter 126. The air filter 126 filters the air prior to the air being provided to internal components of the air pump 122. For example, the air filter 126 may inhibit or prevent the transmission of solids to the internal components of the air pump 122. In this way, the air filter 126 may facilitate prolonged desirable operation of the air pump 122. In some embodiments, the air pump 122 is coupled to a chassis of the vehicle associated with the exhaust gas aftertreatment system 100. In these embodiments, the dosing module 112 is configured to mix the air and the reductant into an air-reductant mixture and to provide the air-reductant mixture into the decomposition chamber 108. In other embodiments, the reductant delivery system 102 does not include the air pump 122 or the air source 124. In such embodiments, the dosing module 112 is not configured to mix the reductant with air.

The exhaust gas aftertreatment system 100 further includes a reductant delivery system controller 128 electrically or communicatively coupled to the dosing module 112 and the reductant pump 116. The reductant delivery system controller 128 is configured to control the dosing module 112 to dose the reductant into the decomposition chamber 108. The reductant delivery system controller 128 may be configured to control the reductant pump 116. The reductant delivery system controller 128 may also be electrically or communicatively coupled to the air pump 122 such that the reductant delivery system controller 128 is configured to control the air pump 122.

The reductant delivery system controller 128 includes a processing circuit 130. The processing circuit 130 includes a processor 132 and a memory 134. The processor 132 may include a microprocessor, an application-specific integrated circuit (ASIC), a field-programmable gate array (FPGA), etc., or combinations thereof. The memory 134 may include, but is not limited to, electronic, optical, magnetic, or any other storage or transmission device capable of providing a processor, ASIC, FPGA, etc. with program instructions. The memory 134 may include a memory chip, Electrically Erasable Programmable Read-Only Memory (EEPROM), Erasable Programmable Read Only Memory (EPROM), flash memory, or any other suitable memory from which the reductant delivery system controller 128 can read instructions. The instructions may include code from any suitable programming language. The memory 134 may include various modules that include instructions which are configured to be implemented by the processor 132.

In various embodiments, the reductant delivery system controller 128 is configured to communicate with a central controller 136 (e.g., engine control unit (ECU), engine control module (ECM), etc.) of an ICE having the exhaust gas aftertreatment system 100. In some embodiments, the central controller 136 and the reductant delivery system controller 128 are integrated into a single controller.

In some embodiments, the central controller 136 is communicable with a display device (e.g., screen, monitor, touch screen, heads up display (HUD), indicator light, etc.). The display device may be configured to change state in response to receiving information from the central controller 136. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller 136. By changing state, the display device may provide an indication to a user (e.g., operator, etc.) of a status (e.g., operation, in need of service, etc.) of the reductant delivery system 102.

The exhaust gas aftertreatment system 100 further includes a catalyst body 110 disposed downstream of the decomposition chamber 108. As a result, the reductant is injected by the injector 120 upstream of the catalyst body 110 such that the catalyst body 110 receives a mixture of the reductant and exhaust gas. The reductant droplets undergo the processes of evaporation, thermolysis, and hydrolysis to form non-NOₓ emissions (e.g., gaseous ammonia, etc.) within the decomposition chamber 108 and/or the exhaust gas conduit system 104. The catalyst body 110 includes an inlet fluidly coupled to the decomposition chamber 108 from which exhaust gas and reductant are received and an outlet fluidly coupled to an end of the exhaust gas conduit system 104.

In some implementations, the particulate filter 106 may be positioned downstream of the decomposition chamber 108. For instance, the particulate filter 106 and the catalyst body 110 may be combined into a single unit. In some implementations, the dosing module 112 may instead be positioned downstream of a turbocharger or upstream of the turbocharger.

While the exhaust gas aftertreatment system 100 has been shown and described in the context of use with a diesel ICE and a H₂ ICE, it is understood that the exhaust gas aftertreatment system 100 may be used with other ICEs, such as gasoline ICEs, hybrid ICEs, propane ICEs, and other similar ICEs.

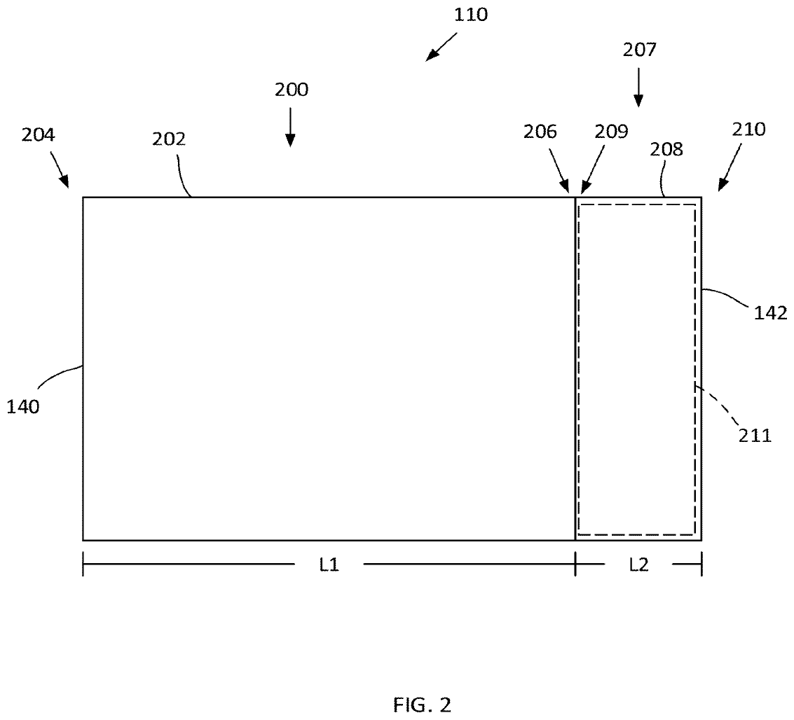

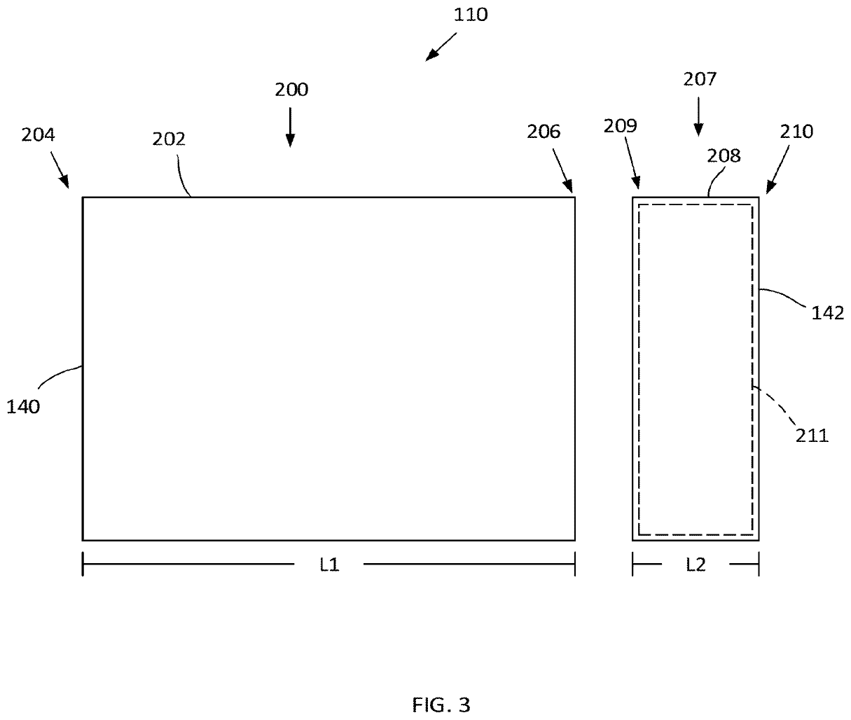

FIGS. 2 and 3 depict the catalyst body 110 according to various example embodiments. The catalyst body 110 is for an exhaust gas aftertreatment system 100. The catalyst body 110 comprises a first portion 200 that comprises a selective catalytic reduction (SCR) catalyst member 202 configured to receive exhaust gas. The SCR catalyst member 202 comprises a first end 204 and a second end 206 opposite the first end 204. The exhaust gas is configured to flow through the SCR catalyst member 202 in a direction from the first end 204 to the second end 206. The catalyst body 110 also comprises a second portion 207 comprising an oxidation catalyst member 208 including a coating 211 thereon at a location proximate the second end 206 of the SCR catalyst member 202. The oxidation catalyst member 208 is fluidly coupled to the SCR catalyst member 202 and receives the exhaust gas from the SCR catalyst member 202 via the second end 206 of the SCR catalyst member 202.

According to various embodiments, an exhaust gas aftertreatment system 100 comprises a decomposition chamber 108 configured to receive an exhaust gas from an engine and a treatment fluid from a dosing module 112. The exhaust gas aftertreatment system 100 further comprises the catalyst body 110 disposed downstream of the decomposition chamber 108. The catalyst body 110 comprises the first portion 200 comprising the selective catalytic reduction (SCR) catalyst member 202 configured to receive the exhaust gas. The SCR catalyst member 202 comprises the first end 204 and the second end 206 opposite the first end 204. The exhaust gas is configured to flow through the SCR catalyst member 202 in a direction from the first end 204 to the second end 206. The catalyst body 110 further comprises the second portion 207 comprising the oxidation catalyst member 208 including the coating 211 thereon at a location proximate the second end 206 of the SCR catalyst member 202. The oxidation catalyst member 208 is fluidly coupled to the SCR catalyst member 202 and receives the exhaust gas from the SCR catalyst member 202 via the second end 206 of the SCR catalyst member 202.

The catalyst body 110 includes an inlet face 140 and outlet face 142 opposite the inlet face 140. The exhaust gas is configured to flow through the catalyst body 110 in a direction from the inlet face 140 to the outlet face 142.

The catalyst body 110 further includes the first portion 200 disposed proximate the inlet face 140. The first portion 200 includes the selective catalytic reduction (SCR) catalyst member 202 configured to receive the exhaust gas. The SCR catalyst member 202 includes the first end 204 and the second end 206 opposite the first end 204. The exhaust gas is configured to flow through the SCR catalyst member 202 in a direction from the first end 204 to the second end 206. The SCR catalyst member 202 is configured to assist in the reduction of NOₓ emissions by accelerating a NOₓ reduction process between the reductant and the NOₓ of the exhaust gas into N₂, H₂O, and/or CO₂. In some embodiments, the SCR catalyst member 202 may include a SCR filter catalyst member having a particulate filter. In some embodiments, the SCR catalyst member 202 may be copper-zeolite based, iron-zeolite based, or vanadium based. In other embodiments, the SCR catalyst member 202 may be non-zeolite based or oxides-based. The SCR catalyst member 202 includes a length L1 extending from the first end 204 to the second end 206. In some embodiments, the length L1 may be between approximately 50 millimeter (mm) and approximately 200 mm (inclusive), although other lengths are possible based upon system requirements.

The catalyst body 110 includes a second portion 207. The second portion 207 includes an oxidation catalyst member 208 (e.g., a diesel oxidation catalyst (DOC), a hydrogen oxidation catalyst, etc.). The oxidation catalyst member 208 is fluidly coupled to the SCR catalyst member 202 and receives the exhaust gas from the SCR catalyst member 202. The oxidation catalyst member 208 includes a first end 209 and a second end 210 opposite the first end 209. The exhaust gas is configured to flow through the oxidation catalyst member 208 in a direction from the first end 209 to the second end 210. The oxidation catalyst member 208 may be configured to oxidize hydrocarbons, carbon monoxide, and/or hydrogen in the exhaust gas.

In some embodiments, as shown in FIG. 2, the first portion 200 and the second portion 207 are coupled such that the second end 206 of the SCR catalyst member 202 is coupled to the first end 209 of the oxidation catalyst member 208. In other embodiments, as shown in FIG. 3, the first portion 200 and the second portion 207 are not coupled (e.g., decoupled, etc.), such that the second end 206 of the SCR catalyst member 202 is not coupled to the first end 209 of the oxidation catalyst member 208.

The oxidation catalyst member 208 includes the coating 211 thereon at a location proximate the second end 206 of the SCR catalyst member 202. The coating 211 comprises a material that is configured to react with the exhaust gas to oxidize hydrogen and other emissions in the exhaust gas. The coating 211 reduces or minimizes hydrogen emissions in the exhaust gas escaping the exhaust gas aftertreatment system 100 into the atmosphere, closed environment (e.g., parking garage, car train transport, etc.), etc. The coating 211 may be disposed uniformly or non-uniformly proximate the second end 206 of the SCR catalyst member 202. For example, the coating 211 may have a uniform thickness or non-uniform thickness.

In some embodiments, the coating 211 comprises precious metals, such as platinum (e.g., Pt), palladium (e.g., Pd), rhodium (e.g., Rh), or their combinations, supported on metal oxides, such as alumina (e.g., Al₂O₃), titania (e.g., TiO₂), ceria (e.g., CeO₂), zirconia (e.g., ZrO₂), or silica (e.g., SiO₂), or silicon carbide (SiC). For example, the coating 211 may comprise Pt/Al₂O₃, Pd/Al₂O₃, or Pt/Pd/Al₂O₃. In other embodiments, the coating 211 comprises non-precious metal-based catalysts, such as MnO₂, CeO₂, FeOₓ, CuO, and NiO. In yet other embodiments, the coating 211 comprises perovskite-based catalysts, such as ABO₃ and A₂BO₄, where “A” represents a large cation (e.g., La and Sr) positioned at an edge of a structure and “B” refers to a small transition metal that represents a main catalytic area surrounded by octahedral of oxygen anions.

The coating 211 may be applied as a zone coating, such that a first zone is coated with a first material, a second zone is coated with a second material, etc. In some embodiments, the first material is the same as the second material. In other embodiments, the first material is different from the second material. In some embodiments, the first zone and the second zone are contiguous, such that there is no or minimal space between the first zone and the second zone. In other embodiments, the first zone and the second zone are non-contiguous, such that there is space between the first zone and the second zone. The space between the first zone and the second zone may be filled with air or another zone coating (e.g., a third zone coating).

The coating 211 may also be applied as a face-painting. The face-painting may comprise a chemical coating using a ceramic washcoat, a glass-based coating, or chemical solutions. The face-painting may be applied as an elevated loading, such that second end 206 of the SCR catalyst member 202 includes an increased amount of coating than an amount of coating employed within fluid channels (e.g., passageways, etc.) of the SCR catalyst member 202. This prevents or minimizes the possibility of the SCR catalyst member 202 becoming less affective at converting NOₓ emissions to non-NOₓ emissions by blocking its fluid channels with the coating 211.

The coating 211 includes a length L2 extending from the first end 209 of the oxidation catalyst member 208 to the second end 210 of the oxidation catalyst member 208. In some particular implementations, for zone coating configurations, the length L2 may be between approximately 25 mm and approximately 200 mm. In other implementations, for face-painting configurations, the length L2 may be between approximately 2 mm and approximately 10 mm (inclusive). In further other implementations, where the second end 206 of the SCR catalyst member 202 is not coupled to the first end 209 of the oxidation catalyst member 208, the length L2 may be between approximately 25 mm and approximately 100 mm (inclusive). Other lengths are possible based upon system requirements.

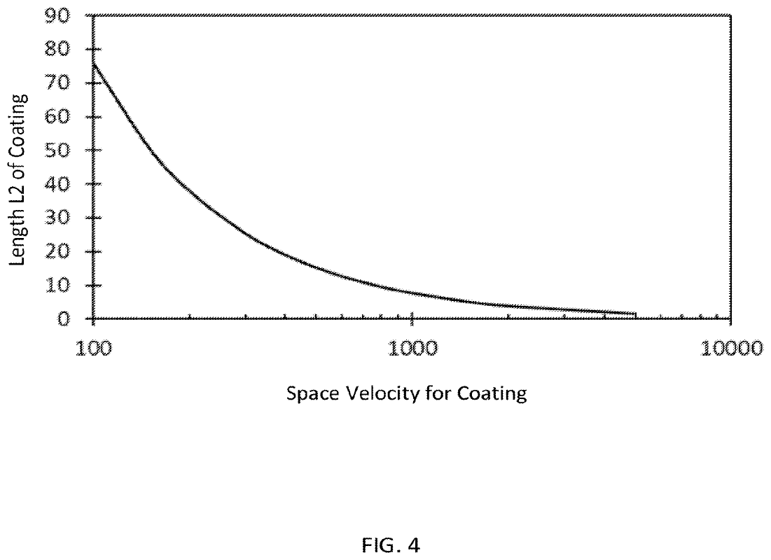

FIG. 4 depicts an example graph comparing the length L2 of the coating 211 versus a space velocity for the coating 211 generated using a mass-transfer based entitlement estimator. The space velocity for the coating 211 may be determined based on an exhaust flow rate (e.g., exhaust volumetric flow rate) and a catalyst member bed volume (e.g., a volume of the oxidation catalyst member 208). The exhaust gas aftertreatment system 100 may include a flow sensor electrically or communicatively coupled to the reductant delivery system controller 128 and configured to measure the exhaust flow rate. In some embodiments, the exhaust flow rate is determined based on fresh air flow rate upstream of the ICE (e.g., using the flow sensor upstream of the ICE) and a total fueling (e.g., injection of fuel, etc.) within the ICE. The space velocity for the coating 211 can be computed by dividing the exhaust flow rate by the catalyst member bed volume (e.g., space_velocity_for_coating=(exhaust_volumetric_flow_rate)/(catalyst member_bed_volume)).

The space velocity for the coating 211 may also be determined based on the space velocity for the SCR catalyst member 202 (e.g., a catalyst element). In some embodiments, the catalyst body 110 (e.g., a full catalyst element) is configured to operate at a space velocity between approximately 20 kh⁻¹ and approximately 120 kh⁻¹ (inclusive).

The space velocity for the SCR catalyst member 202 is dependent on the exhaust flow rate of the ICE. The space velocity for the SCR catalyst member 202 can be computed by dividing the exhaust flow rate by a volume of the SCR catalyst member 202 (e.g., space velocity for_SCR_catalyst_member=(exhaust_volumetric_flow_rate)/(SCR_catalyst_member_volume)). The space velocity for the coating 211 may be determined by multiplying the space velocity for the SCR catalyst member 202 by a coating ratio (e.g., space_velocity_for_coating=(space_velocity_for_SCR_catalyst_member)×(coating ratio)).

The coating ratio may be determined by dividing a sum of length L1 of the SCR catalyst member 202 and the length L2 of the coating 211 (e.g., a length of full catalyst element) by the length L2 of the coating 211. The coating ratio may also be determined by dividing a sum of the volume of the SCR catalyst member 202 and a volume of the coating 211 (e.g., volume of full catalyst element) by the volume of the coating 211. In some embodiments, when the coating 211 is applied as a zone coating, the coating ratio is between approximately 3 and approximately 6 (inclusive), such that the space velocity for the coating 211 is between approximately 60 kh⁻¹ and approximately 1100 kh⁻¹ (inclusive). In other embodiments, when the coating 211 is applied as a face-painting, the coating ratio is between approximately 15 to approximately 100 (inclusive).

$$Space velocity for catalyst element [ {kh}^{- 1} ] = \frac{Exhaust Volumetric Flow Rate [ \frac{L}{h} ]}{Volume of catalyst element [ L ] \times 1000}$$

$$Space velocity for coating [ {kh}^{- 1} ] = Space velocity for catalyst element [ {kh}^{- 1} ] \times Coating Ratio [ ]$$

$$Coating Ratio [ ] = \frac{Length ( or volume ) of full catalyst element [ mm or L ]}{Length ( or volume ) of coating [ mm or L ]} = \frac{L 1 + L 2}{L 2}$$

As illustrated in FIG. 4, a negative exponential relationship appears between the length L2 of the coating 211 and the space velocity for the coating 211 in an example implementation. Based on a target value of the space velocity for the coating 211, a corresponding target value for the length L2 of the coating 211 may be determined. In some embodiments, a range of the length L2 of coating 211 depicted in FIG. 4 is between approximately 2 mm and approximately 90 mm and a range of the space velocity for the coating 211 depicted in FIG. 4 is between approximately 100 kh⁻¹ and approximately 10000 kh⁻¹ in logarithmic scale.

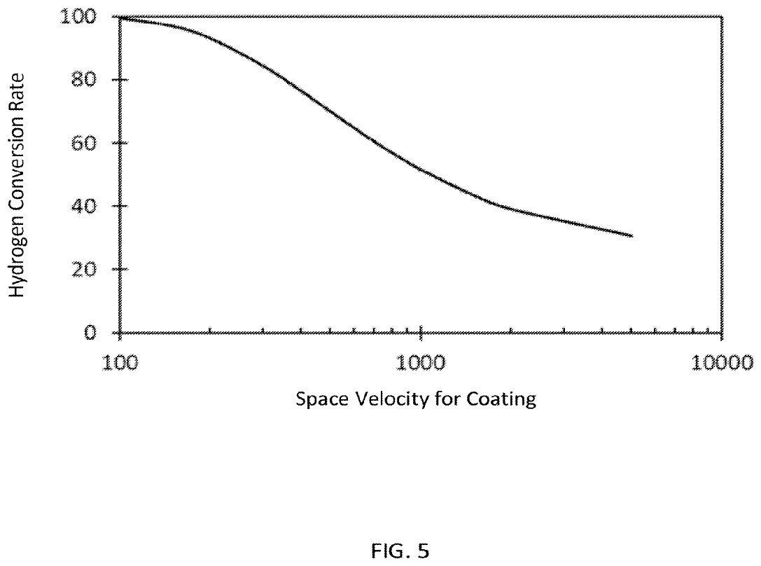

FIG. 5 depicts an example graph of a H₂ conversion rate within the coating 211 versus the space velocity for the coating 211 generated using a mass-transfer based entitlement estimator. The H₂ conversion rate may be determined by (i) a difference between a first quantity of H₂ in the exhaust gas before the oxidation catalyst member 208 and a second quantity of H₂ in the exhaust gas after the oxidation catalyst member 208, and (ii) dividing the difference by the first quantity of H₂ in the exhaust gas (e.g., H₂_conversion_rate=(first quantity_of H₂−second_quantity_of H₂)/first quantity_of H₂).

The exhaust gas aftertreatment system 100 may include a first exhaust sensor disposed upstream of the catalyst body 110. The first exhaust sensor may be electrically or communicatively coupled to the reductant delivery system controller 128 and configured to measure the first quantity of H₂ in the exhaust gas.

The exhaust gas aftertreatment system 100 may also include a second exhaust sensor disposed downstream of the catalyst body 110. The second exhaust sensor may be electrically or communicatively coupled to the reductant delivery system controller 128 and configured to measure the second quantity of H₂ in the exhaust gas. The reductant delivery system controller 128 may be configured to receive the first quantity of H₂ in the exhaust gas and the second quantity of H₂ in the exhaust gas and determine the H₂ conversion rate.

As illustrated in FIG. 5, a negative non-linear relationship appears between the H₂ conversion rate within the coating 211 and the space velocity for the coating 211. Based on a target value of the space velocity for the coating 211, a corresponding predicted value for the H₂ conversion rate may be determined. In some embodiments, a range of the H₂ conversion rate depicted in FIG. 5 is between approximately 0 (e.g., 0%) and approximately 1 (e.g., 100%) and a range of the space velocity for the coating 211 depicted in FIG. 5 is between approximately 100 kh⁻¹ and approximately 10000 kh⁻¹ in logarithmic scale.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the present disclosure.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, exhaust gas, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W to P, etc.) herein are inclusive of their maximum values and minimum values (e.g., W to P includes W and includes P, etc.), unless otherwise indicated. Furthermore, a range of values (e.g., W to P, etc.) does not necessarily require the inclusion of intermediate values within the range of values (e.g., W to P can include only W and P, etc.), unless otherwise indicated.

What is claimed is:

1. A catalyst body for an exhaust gas aftertreatment system, the catalyst body comprising:
a first portion comprising a selective catalytic reduction (SCR) catalyst member configured to receive exhaust gas, the SCR catalyst member comprising:
a first end, and
a second end opposite the first end, wherein the exhaust gas is configured to flow through the SCR catalyst member in a direction from the first end to the second end; and
a second portion comprising an oxidation catalyst member including a coating thereon at a location proximate the second end of the SCR catalyst member, wherein the oxidation catalyst member is fluidly coupled to the SCR catalyst member and receives the exhaust gas from the SCR catalyst member via the second end of the SCR catalyst member.

2. The catalyst body of claim 1, wherein:
the coating comprises a length extending from the second end of the SCR catalyst member outward in the direction from the first end of the SCR catalyst member to the second end of the SCR catalyst member; and
the length of the coating is between 2 mm and 200 mm inclusive.

3. The catalyst body of claim 1, wherein the coating comprises (i) precious metals supported on metal oxides, or (ii) precious metals supported on silicon carbide.

4. The catalyst body of claim 1, wherein the coating comprises a non-precious metal-based catalyst.

5. The catalyst body of claim 1, wherein the coating comprises a perovskite-based catalyst.

6. The catalyst body of claim 1, wherein the SCR catalyst member includes a SCR filter catalyst member having a particulate filter.

7. The catalyst body of claim 1, wherein the SCR catalyst member has a length extending from the first end to the second end, the length between 50 mm and 200 mm inclusive.

8. The catalyst body of claim 1, wherein the coating has a non-uniform thickness.

9. The catalyst body of claim 1, wherein the coating is a zone coating comprising a first zone coated with a first material and a second zone coated with a second material different from the first material.

10. The catalyst body of claim 9, wherein the first zone and the second zone are contiguous.

11. The catalyst body of claim 9, wherein the zone coating has a length extending from the second end of the SCR catalyst member outward in the direction from the first end of the SCR catalyst member to the second end of the SCR catalyst member, the length of the zone coating is between 25 mm and 200 mm inclusive.

12. The catalyst body of claim 9, wherein a coating ratio of the zone coating is between 3 and 6 inclusive, the coating ratio equal to a sum of a volume of the SCR catalyst member and a volume of the zone coating divided by the volume of the zone coating.

13. The catalyst body of claim 1, wherein the coating is a face-painting.

14. The catalyst body of claim 13, wherein the face-painting is applied as an elevated loading, such that the second end of the SCR catalyst member includes an increased amount of the coating than an amount of the coating employed within fluid channels of the SCR catalyst member.

15. The catalyst body of claim 13, wherein the face-painting has a length extending from the second end of the SCR catalyst member outward in the direction from the first end of the SCR catalyst member to the second end of the SCR catalyst member, the length of the face-painting is between 2 mm and 10 mm inclusive.

16. The catalyst body of claim 13, wherein a coating ratio of the face-painting is between 15 and 100 inclusive, the coating ratio equal to a sum of a volume of the SCR catalyst member and a volume of the face-painting divided by the volume of the face-painting.

17. An exhaust gas aftertreatment system, comprising:
a decomposition chamber configured to receive an exhaust gas from an engine and a treatment fluid from a dosing module; and
a catalyst body disposed downstream of the decomposition chamber, the catalyst body comprising:
a first portion comprising a selective catalytic reduction (SCR) catalyst member configured to receive the exhaust gas, the SCR catalyst member comprising:
a first end, and
a second end opposite the first end, wherein the exhaust gas is configured to flow through the SCR catalyst member in a direction from the first end to the second end; and
a second portion comprising an oxidation catalyst member including a coating thereon at a location proximate the second end of the SCR catalyst member, wherein the oxidation catalyst member is fluidly coupled to the SCR catalyst member and receives the exhaust gas from the SCR catalyst member via the second end of the SCR catalyst member.

18. The exhaust gas aftertreatment system of claim 17, wherein the coating is a zone coating comprising a first zone coated with a first material and a second zone coated with a second material, the first zone and the second zone are non-contiguous.

19. The exhaust gas aftertreatment system of claim 18, wherein air is disposed between the first zone and the second zone.

20. The exhaust gas aftertreatment system of claim 17, wherein the catalyst body is configured to operate at a space velocity between 20 kh⁻¹ and 120 kh⁻¹ inclusive.
